(19) United States
(12) Patent Application Publication
(10) Pub. No.: US 2024/0334258 A1
(43) Pub. Date: Oct. 3, 2024

(54) METHOD FOR MULTI-MODAL SERVICE-BASED CELL HANDOVER AND RELATED DEVICES

(71) Applicant: SPREADTRUM COMMUNICATIONS (SHANGHAI) CO., LTD., Shanghai (CN)

(72) Inventor: Lifeng HAN, Shanghai (CN)

(21) Appl. No.: 18/681,999

(22) PCT Filed: Aug. 19, 2022
(86) PCT No.: PCT/CN2022/113603

§ 371 Date: Feb. 7, 2024

(30) Foreign Application Priority Data
Aug. 20, 2021 (CN) 202110962804.X

(51) Int. Cl. H04W 36/00; H04W 36/08

(52) U.S. Cl. CPC H04W 36/0016; H04W 36/08

(57) ABSTRACT

The disclosure provides a method for multi-modal service-based cell handover and related devices. A first base station transmits a first message to a second base station. The first message includes device identifier information of multiple terminals and service identifier information of a first multi-modal service. The multiple terminals are terminals in a source cell of the first base station that carry data of the first multi-modal service. The first message is used for the first base station to request the second base station to perform handover preparation. The first base station receives a second message from the second base station. The second message indicates that the second base station completes the handover preparation. The first base station transmits a third message to the multiple terminals. The third message indicates a target cell for handover.

### CROSS-REFERENCE TO RELATED APPLICATION(S)

This application is a National Stage of International Application No. PCT/CN2022/113603, field Aug. 19, 2022, which claims priority to Chinese Patent Application No. 202110962804.X, filed Aug. 20, 2021, the disclosures of which are hereby incorporated by reference in their entirety.

### TECHNICAL FIELD

This application relates to the field of communication technology, and more particular, to a method for multi-modal service-based cell handover and related devices.

### BACKGROUND

A so-called multi-modal service refers to a service containing various data flows. For example, the data flow can be a video, data obtained by a sensor, tactile data, etc. Different data flows may have different quality of service (QOS) requirements. During processing, all data flows belonging to the same service need to be synchronously transmitted to a receiving end of the data flows for processing. Since the data flows of the same service may be distributed in different terminals, in an existing method, when different terminals need to perform cell handover, one single terminal performs handover independently. This may cause one single terminal of the same service to hand over to a different cell. However, it is difficult to achieve synchronous transmission between terminals in different cells, which results in reduction in the service performance.

### SUMMARY

In a first aspect, embodiments of the disclosure provide a method for multi-modal service-based cell handover. The method includes: transmitting, by a first base station, a first message to a second base station, where the first message includes device identifier information of multiple terminals and service identifier information of a first multi-modal service, the multiple terminals are terminals in a source cell of the first base station that carry data of the first multi-modal service, and the first message is used for the first base station to request the second base station to perform handover preparation; receiving, by the first base station, a second message from the second base station, where the second message indicates that the second base station completes the handover preparation; and transmitting, by the first base station, a third message to the multiple terminals, where the third message indicates a target cell for handover.

In a second aspect, embodiments of the disclosure provide a method for multi-modal service-based cell handover. The method includes: reporting, by a first terminal, a first measurement report to a first base station, where the first terminal is any of multiple terminals, and the multiple terminals are terminals in a source cell of the first base station that carry data of a first multi-modal service; receiving, by the first terminal, a third message from the first base station, where the third message indicates a target cell for handover; and accessing, by the first terminal, the target cell according to the third message.

In a third aspect, embodiments of the disclosure provide a method for multi-modal service-based cell handover. The method includes: receiving, by a second base station, a first message from a first base station, where the first message includes device identifier information of multiple terminals and service identifier information of a first multi-modal service, the multiple terminals are terminals in a source cell of the first base station that carry data of the first multi-modal service; determining, by the second base station, a handover preparation state according to the first message, where the handover preparation state includes handover preparation completion; and transmitting, by the second base station, a second message to the first base station, where the second message indicates that the second base station completes handover preparation.

### BRIEF DESCRIPTION OF THE DRAWINGS

In order to describe more clearly technical solutions of embodiments of the disclosure, the following will give a brief introduction to the accompanying drawings used for describing embodiments. Apparently, the accompanying drawings described below are some embodiments of the disclosure. Based on these drawings, those of ordinary skill in the art can also obtain other drawings without creative effort.

FIG. 1 is a diagram of a system architecture for a method for multi-modal service-based cell handover provided in embodiments of the disclosure.

FIG. 2 is a schematic flowchart of a method for multi-modal service-based cell handover provided in embodiments of the disclosure.

FIG. 3 is a schematic flowchart of another method for multi-modal service-based cell handover provided in embodiments of the disclosure.

FIG. 4 is a schematic flowchart of another method for multi-modal service-based cell handover provided in embodiments of the disclosure.

FIG. 5 is a block diagram of functional units of a device for multi-modal service-based cell handover provided in embodiments of the disclosure.

FIG. 6 is a block diagram of functional units of another device for multi-modal service-based cell handover provided in embodiments of the disclosure.

FIG. 7 is a block diagram of functional units of another device for multi-modal service-based cell handover provided in embodiments of the disclosure.

### DETAILED DESCRIPTION

To facilitate better understanding of solutions of the disclosure by those skilled in the art, the technical solutions in implementations of the disclosure are clearly and completely described hereinafter with reference to the accompanying drawings in the implementations of the disclosure. Apparently, the described implementations are merely part of rather than all of the implementations of the disclosure. All other implementations obtained by those of ordinary skill in the art based on the implementations provided herein without creative efforts shall fall within the scope of the disclosure.

The terms “first”, “second”, and the like used in the specification, the claims, and the accompany drawings of the disclosure are used to distinguish different objects rather than describe a particular order. The terms “include”, “comprise”, and “have” as well as variations thereof are intended to cover non-exclusive inclusion. For example, a process, method, system, product, or apparatus including a series of steps or units is not limited to the listed steps or units, it can optionally include other operations or units that are not listed; alternatively, other operations or units inherent to the process, method, product, or device can be included either.

It should be understood that the term “and/or” herein only describes an association relationship between associated objects, which means that there can be three relationships. For example, A and/or B can mean A alone, both A and B exist, and B alone. In addition, the character “/” herein indicates that the associated objects are in an “or” relationship. “A plurality of” or “multiple” in embodiments of the disclosure refers to two or more.

The “connection” in embodiments of the disclosure refers to various manners of connection, such as direct connection or indirect connection, so as to implement communication between devices, which is not limited herein.

The term “embodiment” herein means that a particular feature, structure, or characteristic described in conjunction with the embodiment may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein may be combined with other embodiments.

First, the background and terms in embodiments of the disclosure are described.

Multi-modal service, where one multi-modal service may contain multiple QoS flows, and one QoS flow may contain one or more data flows. The data flow may be an internet protocol (IP) data flow or a non-IP data flow. One multi-modal service also contains one or more protocol data unit (PDU) sessions, or one PDU session contains one or more multi-modal services. QoS flows belonging to the same multi-modal service may be distributed in different terminals.

Cell handover, inter-cell handover in the mobile communication system means that a mobile terminal completes, under the control of a radio access network, the migration of a radio link connection from a source cell to a target cell, and is a basic technical means to guarantee a seamless mobile communication services and refers to an operation of interchanging an ongoing call between radio channels in different cells without interruption.

In embodiments of the disclosure, a base station (BS) may also be referred to as a base station device, and is a device deployed in a radio access network to provide wireless communication functions. For example, a device that provides a base station function in a 2G network includes a base transceiver station (BTS) and a base station controller (BSC). A device that provides the base station function in a 3G network includes a Node B and a radio network controller (RNC). A device that provides the base station function in a 4G network includes an evolved node B (eNB). In a wireless local area network (WLAN), a device that provides the base station function is an access point (AP). A device that provides the base station function in a 5G new radio (NR) includes gNB and a continuously evolved Node B (ng-eNB), where gNB and the terminal use NR technology for communication, ng-eNB and the terminal use evolved universal terrestrial radio access (E-UTRA) technology for communication, and both gNB and ng-eNB can be connected to a 5G core network. The base station also refers to a device that provides the base station function in a new communication system in the future.

In embodiments of the disclosure, a base station controller is a device for managing base stations, such as a base station controller (BSC) in a 2G network, a radio network controller (RNC) in a 3G network, or a device that controls and manages a base station in a new communication system in the future.

In embodiments of the disclosure, a network refers to a communication network that provides communication services for terminals, including a base station of a radio access network, a base station controller of a radio access network, and a device on a core network side.

In embodiments of the disclosure, a terminal may refer to various forms of UE, access terminal, user unit, user station, mobile station (MS), remote station, remote terminal, mobile equipment, user terminal, terminal equipment, wireless communication equipment, user agent or user device. The terminal equipment may further be a cellular phone, a cordless phone, a session initiation protocol (SIP) phone, a wireless local loop (WLL) station, a personal digital assistant (PDA), a handheld device with a wireless communication function, a computing device or other processing devices connected to a wireless modems, an in-vehicle device, a wearable device, a terminal equipment in the future 5G network, or a terminal equipment in a future evolved public land mobile network (PLMN), which is not limited herein.

In embodiments of the disclosure, a core network may be an evolved packet core (EPC), 5G core network or a new core network in future communication systems. The 5G core network is composed of a set of devices, implements access and mobility management function (AMF) providing functions such as mobility management function, user plane function (UPF) providing functions such as packet routing and forwarding and quality of service (QOS) management, and session management function (SMF) providing functions such as session management and IP address allocation and management. EPC can be composed of MME that provides functions such as mobility management and gateway selection, serving gateway (S-GW) that provides functions such as data packet forwarding, and PDN gateway (P-GW) that provides functions such as terminal address allocation and rate control.

In embodiments of the disclosure, a unidirectional communication link from an access network to a terminal is defined as a downlink, data transmitted on the downlink is downlink data, and a transmission direction of the downlink data is called a downlink direction. Besides, a unidirectional communication link from a terminal to an access network is defined as an uplink, data transmitted on the uplink is uplink data, and a transmission direction of the uplink data is called an uplink direction.

The disclosure is applicable to a fifth generation (5G) communication system, a fourth generation (4G) communication system, a third generation (3G) communication system, and also various new communication systems in the future, such as a sixth generation (6G) communication system, a seventh generation (7G) communication system, etc. The disclosure is also applicable to different network architectures, including but not limited to a relay network architecture, a dual-link architecture, a vehicle-to-everything architecture, etc., which is not limited herein.

When processing a multi-modal service, synchronous transmission of the multi-modal service in the communication system is required. For synchronous transmission, terminals involved in the multi-modal service are preferably in the same cell. When cell handover is required, how multiple terminals involved in the multi-modal service can simultaneously hand over to the same cell is a problem.

To solve the above problem, the disclosure provides a method for multi-modal service-based cell handover, which allows terminals involved in a multi-modal service to synchronously hand over to the same cell, thereby realizing synchronous transmission of the multi-modal service in the communication system.

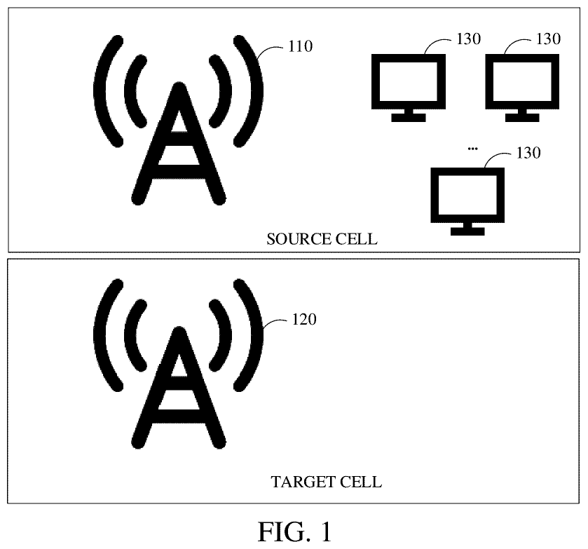

A system architecture for a method for multi-modal service-based cell handover in embodiments of the disclosure will be described below with reference to FIG. 1. FIG. 1 is a diagram of a system architecture for a method for multi-modal service-based cell handover provided in embodiments of the disclosure. The system architecture 100 includes a first base station 110, a second base station 120, and a terminal 130. The first base station 110, the second base station 120, and the terminal 130 are connected to each other.

The first base station 110 is a base station of a source cell. The second base station 120 is a base station of a target cell. The number of the first base station 110 and the number of the second base station 120 are not specifically limited. The terminal 130 is a terminal device supporting a first multi-modal service. It can be understood that all terminal devices transmitting the first multi-modal service, that is, all terminals 130, are initially located in the source cell, and can synchronously hand over to the target cell when cell handover is required, which facilitates synchronous transmission of the first multi-modal service in the communication system.

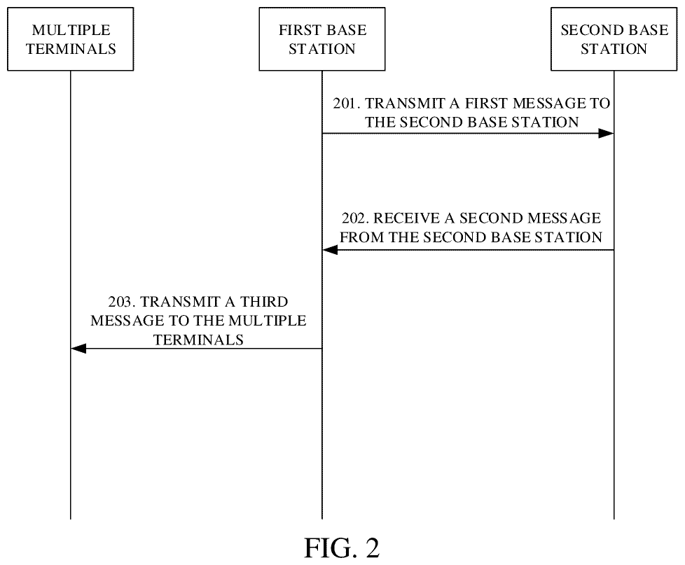

After introducing the system architecture for the method for cell handover, a method for multi-modal service-based cell handover in embodiments of the disclosure will be described below with reference to FIG. 2. FIG. 2 is a schematic flowchart of a method for multi-modal service-based cell handover provided in embodiments of the disclosure. The method includes the following.
Step 201: A first base station transmits a first message to a second base station.

The first message includes device identifier information of multiple terminals and service identifier information of a first multi-modal service. The multiple terminals are terminals in a source cell of the first base station that carry data of the first multi-modal service. It can be understood that the first message is a handover request transmitted by the first base station to the second base station to request the second base station to perform handover preparation. The first message includes but is not limited to a HANDOVER REQUEST message and a HANDOVER REQUIRED message.

In a possible embodiment, the first message is one message. The first message may specifically include at least one of: a terminal identifier set, a first service identifier, a first data flow identifier set, a first admission identifier, and a second admission identifier. The terminal identifier set indicates the multiple terminals. The first service identifier indicates the first multi-modal service. The first data flow identifier set indicates data flows of the first multi-modal service. The first admission identifier includes an entire admission identifier or a partial admission identifier. The entire admission identifier indicates that the second base station admits all of the data flows of the first multi-modal service. The partial admission identifier indicates that the second base station admits part of the data flows of the first multi-modal service. The terminal identifier set is a set of multiple terminal identifiers. The first data flow identifier set is a set of multiple QoS flow identifiers. Different terminals carry different data of the first multi-modal service. Data in the QoS flow is data of the first multi-modal service. The first admission identifier can be an entire admission indication of the first multi-modal service. In this case, the second base station needs to make an entire admission decision on multiple QoS flows of the first multi-modal service. That is, if the second base station admits the multi-modal service, the second base station needs to admit all of the QoS flows of the multi-modal service. The first admission identifier can also be a partial admission indication of the first multi-modal service. That is, only part of the QoS flows of the multi-modal service need to be admitted. That is, if the second base station admits the multi-modal service, the second base station only needs to admit part of the QoS flows of the multi-modal service. Further, the first message also includes the second admission identifier. The second admission identifier indicates whether a certain QoS flow should be admitted when the first multi-modal service is admitted. If the certain QoS flow should be admitted, when the QoS flow fails to be admitted, the first multi-modal service fails to be admitted.

In a possible embodiment, the first message is multiple messages. The first message includes at least one of: multiple terminal identifiers, multiple first service identifiers, multiple data flow identifiers, and multiple admission identifiers. Each terminal identifier indicates a corresponding terminal. Each data flow identifier indicates one data flow of the first multi-modal service transmitted by a corresponding terminal. Each admission identifier indicates that the second base station needs to admit a data flow transmitted by a corresponding terminal. Alternatively, each admission identifier indicates that the second base station may not admit a data flow transmitted by a corresponding terminal. It can be understood that each first message here includes at least one of: one terminal identifier, one first service identifier, one data flow identifier, and one admission identifier. A time interval between arrivals of the multiple first messages at the second base station is extremely small, and thus the multiple first messages can be ideally default to arriving simultaneously, which is not limited herein. The second base station can determine whether the handover preparation can be completed according to all first messages received.

Further, the first message also includes a second admission identifier. The second admission identifier indicates whether a certain QoS flow should be admitted when the service is admitted. If the certain QoS flow should be admitted, when the QoS flow fails to be admitted, the service fails to be admitted.

Further, any of the first messages may indicate the number or terminals carrying the first service or terminal identifiers of the terminals.

It can be seen that the first base station transmits the first message to the second base station, and the first message contains the entire terminal carrying the first multi-modal service, thereby providing information for a subsequent decision of handover to the target base station.

In addition, one first message that integrates device identifier information of all terminals and service identifier information of the first multi-modal service can be transmitted, or multiple first messages each containing device identifier information of a corresponding terminal and the service identifier information of the first multi-modal service can be transmitted, thereby improving the flexibility of transmission.
Step 202: The first base station receives a second message from the second base station.

The second message indicates that the second base station completes the handover preparation. The second message may be HANDOVER REQUEST ACKNOWLEDGE. For relevant steps of the handover preparation, reference can be made to the general method for cell handover, which will not be repeated herein.
Step 203: The first base station transmits a third message to the multiple terminals.

The third message indicates a target cell for handover.

In a possible embodiment, the third message may be a handover command, and the first base station transmits the handover command to the multiple terminals, where the handover command indicates the multiple terminals to hand over to the target cell.

In a possible embodiment, the third message may be a conditional handover command, where the conditional handover command includes handover conditions of candidate cells, and the target cell is any of the candidate cells. It can be understood that there can be one or more candidate cells. After receiving the conditional handover command, the terminal can access the target cell when the handover condition of the target cell is satisfied. The handover condition of the candidate cell means that if the handover condition is satisfied, the terminal will list the candidate cell as a target cell for handover and access the target cell. The handover condition of the candidate cell may be that a signal quality of the candidate cell is higher than a certain threshold and/or a signal quality of a source cell is lower than a certain threshold, or a difference between the signal quality of the candidate cell and the signal quality of the source cell is higher than a certain threshold, which is not limited herein.

It can be seen that, through the above method, terminals involved in a multi-modal service can synchronously hand over to the same cell, thereby realizing synchronous transmission of the multi-modal service in the communication system.

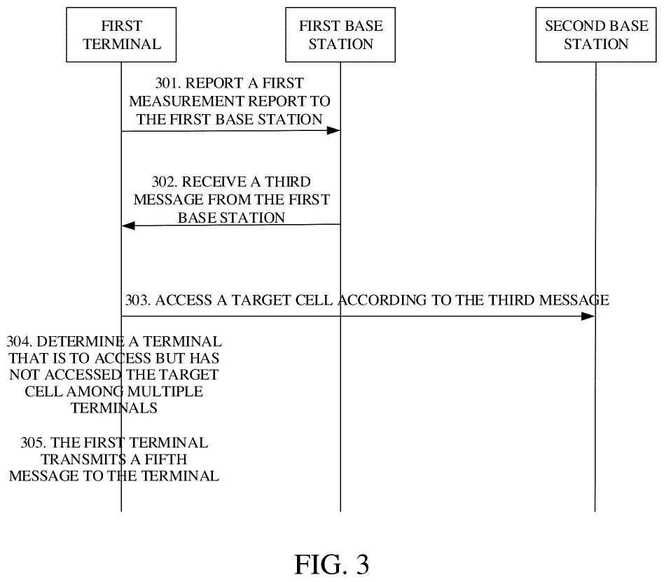

Another method for multi-modal service-based cell handover in embodiments of the disclosure will be described below with reference to FIG. 3. FIG. 3 is a schematic flowchart of another method for multi-modal service-based cell handover provided in embodiments of the disclosure. The method includes the following.
Step 301: A first terminal reports a first measurement report to a first base station.

The first terminal is any of multiple terminals, and the multiple terminals are terminals in a source cell of the first base station that carry data of a first multi-modal service.

The first terminal can measure relevant information such as a channel quality of the source cell and a channel quality of a nearby cell, and report the relevant information to the first base station. The first base station can determine whether cell handover is required according to a measurement report reported by the first terminal or any terminal. The reporting of the measurement report may include a measurement configuration phase, a measurement execution phase, and a measurement reporting phase, and reference can be made to the description of existing measurement reporting, which will not be repeated herein.
Step 302: The first terminal receives a third message from the first base station.

The third message indicates a target cell for handover. The third message may be a handover command or a conditional handover command.
Step 303: The first terminal accesses the target cell according to the third message.

In a possible embodiment, the first terminal may initiate access to the target cell according to the handover command.

In a possible embodiment, the first terminal may initiate access to the target cell in response to a handover condition of the target cell contained in the conditional handover command being satisfied.

In a possible embodiment, in step 304, the first terminal determines a terminal that is to access but has not accessed the target cell among the multiple terminals.

The first terminal may determine the terminal that is to access but has not accessed the target cell among the multiple terminals according to a terminal identifier set or a terminal identifier of a terminal other than the first terminal. It can be understood that there may be a mapping between all terminals carrying the first multi-modal service. For example, these terminals all belong to the same terminal set and can communicate with each other.
Step 305: The first terminal transmits a fifth message to the terminal.

The fifth message includes a target cell identifier and indicates the terminal to access the target cell.

It can be seen that, through the above method, a terminal that has accessed the target cell transmits the fifth message to a terminal that is to access the target cell to indicate the terminal that is to access the target cell to access the target cell, which can improve the efficiency of synchronization handover and allow terminals involved in a multi-modal service to synchronously hand over to the same cell, thereby realizing synchronous transmission of the multi-modal service in the communication system.

For steps not described in detail above, reference can be made to some or part of steps of the method described in FIG. 2, which will not be repeated herein.

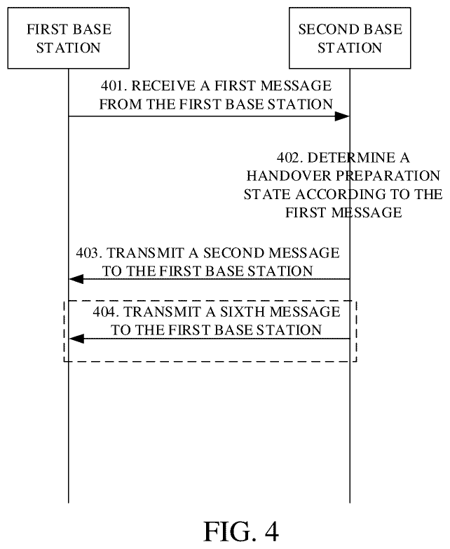

Another method for multi-modal service-based cell handover in embodiments of the disclosure will be described below with reference to FIG. 4. FIG. 4 is a schematic flowchart of another method for multi-modal service-based cell handover provided in embodiments of the disclosure. The method includes the following.
401. A second base station receives a first message from a first base station.

The first message includes device identifier information of multiple terminals and service identifier information of a first multi-modal service. The multiple terminals are terminals in a source cell corresponding to the first base station that support the first multi-modal service.

In a possible embodiment, the second base station receives one first message from the first base station. The first message includes at least one of: a terminal identifier set, a first service identifier, a first data flow identifier set, a first admission identifier, and a second admission identifier. The terminal identifier set indicates the multiple terminals. The first service identifier indicates the first multi-modal service. The first data flow identifier set indicates data flows of the first multi-modal service. The first admission identifier includes an entire admission identifier or a partial admission identifier. The entire admission identifier indicates that the second base station admits all of the data flows of the first multi-modal service. The partial admission identifier indicates that the second base station admits part of the data flows of the first multi-modal service.

In a possible embodiment, the second base station receives multiple first messages from the first base station. Each first message includes at least one of: one terminal identifier, one first service identifier, one data flow identifier, one first admission identifier, and one second admission identifier. Each terminal identifier indicates a corresponding terminal. Each data flow identifier indicates one data flow of a multi-modal service transmitted by a corresponding terminal. Each first admission identifier indicates that the second base station admits all of data flows of the first multi-modal service transmitted by a corresponding terminal or indicates that the second base station can only admit part of the data flows of the first multi-modal service transmitted by the corresponding terminal. Each second admission identifier indicates whether any of data flows should be admitted when the first multi-modal service is admitted. If the data flow should be admitted, when the data flow fails to be admitted, the first multi-modal service fails to be admitted.

It can be seen that the second base station can receives the first message from the first base station in various forms.
Step 402: The second base station determines a handover preparation state according to the first message.

The handover preparation state includes handover preparation completion and handover preparation failure.

In a possible embodiment, the second base station may determine the handover preparation state according to at least one of: a terminal identifier set, a first service identifier, a first data flow identifier set, a first admission identifier, and a second admission identifier included in the first message.

In a possible embodiment, the second base station may determine the handover preparation state according to at least one of: one terminal identifier, one first service identifier, one data flow identifier, and one admission identifier included in each of multiple first messages.

Specifically, when the first admission identifier is the entire admission identifier, the handover preparation completion means that the second base station can admit all of the data flows of the first multi-modal service. When the first admission identifier is the partial admission identifier, the handover preparation completion means that the second base station can admit part of the data flows that the second admission identifier corresponding to the first multi-modal service indicates should be admitted. The admission of the data flow by the second base station can match a corresponding admission identifier in each first message.

When the first admission identifier is the entire admission identifier, the handover preparation failure means that the second base station fails to admit all of the data flows of the first multi-modal service. When the first admission identifier is the partial admission identifier, the handover preparation failure means that the second base station fails to admit part of the data flows that the second admission identifier corresponding to the first multi-modal service indicates should be admitted. The admission of the data flow by the second base station fails to match a corresponding admission identifier in each first message.

When the handover preparation state is handover preparation completion, proceed to step 403. When the handover preparation state is handover preparation failure, proceed to step 404.
Step 403: The second base station transmits a second message to the first base station.

The second message indicates that the second base station completes handover preparation. The second message includes HANDOVER REQUEST ACKNOWLEDGE.
Step 404: The second base station transmits a sixth message to the first base station.

The sixth message includes HANDOVER PREPARATION FAILURE or ANDOVER REQUEST ACKNOWLEDGE and indicates that the first multi-modal service fails to be admitted.

It can be seen that, this allows terminals involved in a multi-modal service to synchronously hand over to the same cell, thereby realizing synchronous transmission of the multi-modal service in the communication system.

For steps not described in detail above, reference can be made to some or part of steps of the method described in FIGS. 2 and 3, which will not be repeated herein.

For ease of understanding, a method for multi-modal service-based cell handover in embodiments of the disclosure is illustrated below, with the following four embodiments as examples.

### Embodiment 1

In embodiments of the disclosure, the first message is one message.

Multiple terminals in a source cell that carry a first multi-modal service report a measurement report to a first base station.

The first base station determines that the multiple terminals need to hand over to a target cell. The first base station transmits a first message to a second base station. In this case, the first message is one message and includes at least one of: a terminal identifier set, a first service identifier, a first data flow identifier set, a first admission identifier, and a second admission identifier. The terminal identifier set indicates the multiple terminals. The first service identifier indicates the first multi-modal service. The first data flow identifier set indicates data flows of the first multi-modal service. The first admission identifier includes an entire admission identifier or a partial admission identifier. The entire admission identifier indicates that the second base station admits all of the data flows of the first multi-modal service. The partial admission identifier indicates that the second base station admits part of the data flows of the first multi-modal service. The second admission identifier indicates whether a certain QoS flow should be admitted when the service is admitted. If the certain QoS flow should be admitted, when the QoS flow fails to be admitted, the service fails to be admitted.

The second base station receives the first message from the first base station and performs handover preparation. If the second base station can admit the first multi-modal service, the second base station transmits a second message to the first base station. If the second base station cannot admit the first multi-modal service, the second base station transmits a sixth message to the first base station. The second message may be HANDOVER REQUEST ACKNOWLEDGE. The sixth message may be HANDOVER PREPARATION FAILURE or ANDOVER REQUEST ACKNOWLEDGE.

After receiving the second message from the second base station, the first base station transmits a handover command to the multiple terminals.

The multiple terminals initiate handover in a target cell according to the handover command.

In this way, the cell handover of the multiple terminals carrying the first multi-modal service is completed.

### Embodiment 2

In embodiments of the disclosure, the first message is multiple messages.

Multiple terminals in a source cell that carry a first multi-modal service report a measurement report to a first base station.

The first base station determines that the multiple terminals need to hand over to a target cell. The first base station transmits first messages each corresponding to one terminal to a second base station. Each first message includes at least one of: one terminal identifier, one first service identifier, one data flow identifier, one first admission identifier, and one second admission identifier. Each terminal identifier indicates a corresponding terminal. Each data flow identifier indicates one data flow of a multi-modal service transmitted by a corresponding terminal. Each admission identifier indicates that the second base station admits a data flow transmitted by a corresponding terminal or indicates that the second base station does not admit the data flow transmitted by the corresponding terminal.

The second base station receives the multiple first messages from the first base station and performs handover preparation. If the second base station can admit the first multi-modal service, the second base station transmits a second message to the first base station. If the second base station cannot admit the first multi-modal service, the second base station transmits a sixth message to the first base station. The second message may be HANDOVER REQUEST ACKNOWLEDGE. The sixth message may be HANDOVER PREPARATION FAILURE or ANDOVER REQUEST ACKNOWLEDGE. It should be noted that after receiving all of the first messages, the second base station can determine whether the first multi-modal service can be admitted.

After receiving the second message from the second base station, the first base station transmits a handover command to the multiple terminals.

The multiple terminals initiate handover in a target cell according to the handover command.

In this way, the cell handover of the multiple terminals carrying the first multi-modal service is completed.

### Embodiment 3

In embodiments of the disclosure, there is conditional handover. In the conditional handover, after a source base station and a target base station successfully prepare for handover, the source base station transmits a conditional handover command to a terminal. The conditional handover command includes a condition that triggers handover by the terminal, such as a trigger of a measurement event.

Multiple terminals in a source cell that carry a first multi-modal service report a measurement report to a first base station.

The first base station determines candidate base stations. The candidate base stations include a second base station and a third base station. The first base station may transmit a first message to the second base station and the third base station respectively in the manner of Embodiment 1 or Embodiment 2, so that the second base station and the third base station can successfully prepare for handover.

The first base station transmits a conditional handover command to the multiple terminals. The conditional handover command includes a conditional handover command of a second cell and a conditional handover command of a third cell. When any of the terminals satisfies the conditional handover command of the second cell, the terminal hands over to the second cell. When any of the terminals satisfies the conditional handover command of the third cell, the terminal hands over to the third cell. The second base station corresponds to the second cell. The third base station corresponds to the third cell. In this case, the second cell can be regarded as a target cell.

The second base station transmits a fourth message to the first base station or the third base station. The fourth message includes a first service identifier, a target cell identifier, and a terminal access state identifier. The terminal access state identifier includes a terminal identifier corresponding to a terminal that has not accessed the target cell in multiple terminal identifiers or a terminal identifier set and a terminal identifier corresponding to a terminal that has accessed the target cell in the multiple terminal identifiers or the terminal identifier set.

The first base station transmits a handover command to a terminal that is to access but has not accessed the target cell, where the handover command indicates the terminal to hand over to the target cell.

It can be understood that the candidate base station may only include the second base station. In this case, only the first base station receives the fourth message from the second base station. The number of candidate base stations is not limited herein.

It can be seen that, in this way, the base stations can notify each other, so that the multiple terminals carrying the first multi-modal service can synchronously hand over to the same cell.

### Embodiment 4

In embodiments of the disclosure, there is conditional handover. In the conditional handover, after a source base station and a target base station successfully prepare for handover, the source base station transmits a conditional handover command to a terminal. The conditional handover command includes a condition that triggers handover by the terminal, such as a trigger of a measurement event.

Multiple terminals in a source cell that carry a first multi-modal service report a measurement report to a first base station.

The first base station determines candidate base stations. The candidate base stations include a second base station and a third base station. The first base station may transmit a first message to the second base station and the third base station respectively in the manner of Embodiment 1 or Embodiment 2, so that the second base station and the third base station can successfully prepare for handover.

The first base station transmits a conditional handover command to the multiple terminals. The conditional handover command includes a conditional handover command of a second cell and a conditional handover command of a third cell. When any of the terminal satisfies the conditional handover command of the second cell, the terminal hands over to the second cell. When any of the terminals satisfies the conditional handover command of the third cell, the terminal hands over to the third cell. The second base station corresponds to the second cell. The third base station corresponds to the third cell. In this case, the second cell can be regarded as a target cell.

A terminal that has accessed the target cell may transmit a fifth message to a terminal that is to access but has not accessed the target cell. The fifth message may indicate the target cell for handover.

The terminal that is to access but has not accessed the target cell initiates access to the target cell according to the fifth message.

It can be seen that, through communication between the terminals carrying the first multi-modal service, the multiple terminals carrying the first multi-modal service can synchronously hand over to the same cell.

In conclusion, through the above method, terminals involved in a multi-modal service can synchronously hand over to the same cell, thereby realizing synchronous transmission of the multi-modal service in the communication system.

The following are device embodiments disclosed in embodiments of the disclosure. For a part not described in detail in the device embodiments, reference can be made to the technical details disclosed in above method embodiments.

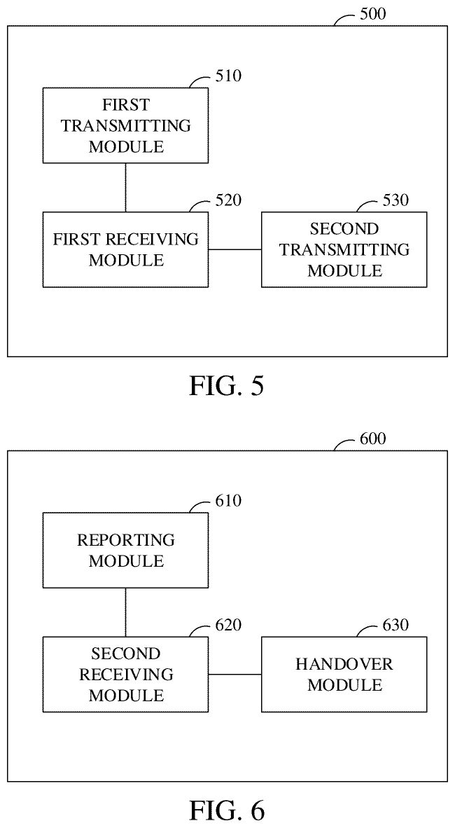

FIG. 5 illustrates a device for multi-modal service-based cell handover provided in embodiments of the disclosure. The device 500 includes a first transmitting module 510, a first receiving module 520, and a second transmitting module 530.

The first transmitting module 510 is configured to transmit a first message to a second base station, where the first message includes device identifier information of multiple terminals and service identifier information of a first multi-modal service, and the multiple terminals are terminals in a source cell of the first base station that carry data of the first multi-modal service. The first receiving module 520 is configured to receive a second message from the second base station, where the second message indicates that the second base station completes the handover preparation. The second transmitting module 530 is configured to transmit a third message to the multiple terminals, where the third message indicates a target cell.

It can be understood that for the specific implementation of functional units included in the device for cell handover 500, reference can be made to foregoing embodiments, which will not be repeated herein.

FIG. 6 illustrates another device for multi-modal service-based cell handover provided in embodiments of the disclosure. The device 600 includes a reporting module 610, a second receiving module 620, and a handover module 630.

The reporting module 610 is configured to report a first measurement report to a first base station, where the first terminal is any of multiple terminals, and the multiple terminals are terminals in a source cell of the first base station that carry data of a first multi-modal service.

The second receiving module 620 is configured to receive a third message from the first base station, where the third message indicates a target cell. The handover module 630 is configured to access the target cell according to the third message.

It can be understood that for the specific implementation of functional units included in the device for cell handover 600, reference can be made to foregoing embodiments, which will not be repeated herein.

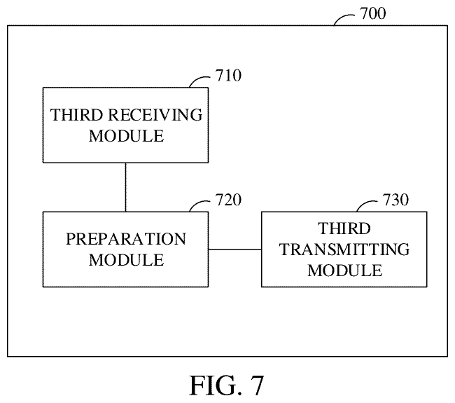

FIG. 7 illustrates another device for multi-modal service-based cell handover provided in embodiments of the disclosure. The device 700 includes a third receiving module 710, a preparation module 720, and a third transmitting module 730.

The third receiving module 710 is configured to receive a first message from a first base station, where the first message includes device identifier information of multiple terminals and service identifier information of a first multi-modal service, the multiple terminals are terminals in a source cell of the first base station that carry data of the first multi-modal service. The preparation module 720 is configured to determine a handover preparation state according to the first message, where the handover preparation state includes handover preparation completion. The third transmitting module 730 is configured to transmit a second message to the first base station, where the second message indicates that the second base station completes handover preparation.

It can be understood that for the specific implementation of functional units included in the device for cell handover 700, reference can be made to foregoing embodiments, which will not be repeated herein.

Embodiments of the disclosure provide a base station device. The base station device includes a memory and a processor. The memory stores computer programs executable on the processor. The computer programs are operable with the processor to perform steps of the method for cell handover described in any of FIG. 2 of embodiments of the disclosure.

Embodiments of the disclosure provide a terminal device. The terminal device includes a memory and a processor. The memory stores computer programs executable on the processor. The computer programs are operable with the processor to perform steps of the method for cell handover described in any of FIG. 3 of embodiments of the disclosure.

Embodiments of the disclosure provide a base station device. The base station device includes a memory and a processor. The memory stores computer programs executable on the processor. The computer programs are operable with the processor to perform steps of the method for cell handover described in any of FIG. 4 of embodiments of the disclosure.

The computer-readable storage medium may be a tangible device that can hold and store instructions for use by the device executing the instructions. The computer-readable storage medium may be, for example, but not limited to, an electrical storage device, a magnetic storage device, an optical storage device, an electromagnetic storage device, a semiconductor storage device, or any suitable combination thereof. More specific examples (non-exhaustive list) of computer readable storage media include: portable computer disks, hard disks, random access memory (RAM), read-only memory (ROM), erasable programmable read-only memory (EPROM or flash memory), static random access memory (SRAM), portable compact disk read-only memory (CD-ROM), digital versatile disk (DVD), memory sticks, floppy disks, mechanically coded devices, such as punch cards or raised structures in grooves with instructions stored thereon, and any suitable combination thereof. The computer-readable storage media, as used herein, are not to be interpreted as transient signals per se, such as radio waves or other freely propagating electromagnetic waves, electromagnetic waves propagating through waveguides or other transmission media (e.g., light pulses through fiber optic cables), or electrical signals transmitted through electrical wires.

The computer readable program instructions described herein may be downloaded to various computing/processing devices from the computer readable storage medium, or to an external computer or external storage device over a network such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in the computer-readable storage medium in each computing/processing device.

The computer program instructions for carrying out operations of the disclosure may be assembly instructions, instruction set architecture (ISA) instructions, machine instructions, machine-dependent instructions, microcode, firmware instructions, state setting data, or source or object codes written in any combination of one or more programming languages, including object-oriented programming languages, such as Smalltalk, C++, etc., and conventional procedural programming languages, such as the “C” language or similar programming languages. The computer-readable program instructions may be executed entirely on the user's computer, partly on the user's computer, as a stand-alone software package, partly on the user's computer and partly on a remote computer, or entirely on the remote computer or server. In the case of a remote computer, the remote computer may be connected to the user's computer through any kind of network, including a local area network (LAN) or a wide area network (WAN), or may be connected to an external computer (e.g., using an Internet service provider to connect via the Internet). In some embodiments, custom electronic circuits, such as programmable logic circuits, field programmable gate arrays (FPGAs), or programmable logic arrays (PLAs), can be personalized by utilizing state information of computer-readable program instructions. The custom electronic circuits execute the computer-readable program instructions to implement various aspects of the disclosure.

Aspects of the disclosure are described herein with reference to flowchart and/or block diagrams of methods, apparatus (systems) and computer program products according to embodiments of the disclosure. It will be understood that each block of the flowchart and/or block diagrams, and combinations of blocks in the flowchart and/or block diagrams, can be implemented by the computer-readable program instructions.

These computer-readable program instructions may be provided to a processor of a general purpose computer, special purpose computer or other programmable data processing apparatus to produce a machine that causes the instructions, when executed by the processor of the computer or other programmable data processing apparatus, produce a means for implementing the functions/acts specified in one or more blocks of the flowchart and/or block diagrams. These computer-readable program instructions can also be stored in a computer-readable storage medium, these instructions causing a computer, programmable data processing apparatus and/or other equipment to operate in a specific manner, so that the computer-readable medium storing the instructions includes an article of manufacture including instructions for implementing various aspects of the functions/acts specified in one or more blocks of the flowchart and/or block diagrams.

The computer-readable program instructions can also be loaded onto a computer, other programmable data processing apparatus, or other equipment to cause a series of operational steps to be performed on the computer, other programmable data processing apparatus, or other equipment to produce a computer-implemented process, thereby causing instructions executing on the computer, other programmable data processing apparatus, or other device to implement the functions/acts specified in one or more blocks of the flowcharts and/or block diagrams.

The flowchart and block diagrams in the accompany drawings illustrate the architecture, functionality, and operation of possible implementations of systems, methods and computer program products according to various embodiments of the disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the figures. For example, two blocks in succession may, in fact, be executed substantially concurrently, or the blocks may sometimes be executed in the reverse order, depending upon the functionality involved. It is also noted that each block of the block diagrams and/or flowchart, and combinations of blocks in the block diagrams and/or flowcharts, can be implemented in dedicated hardware-based systems that perform the specified functions or actions, or can be implemented in a combination of dedicated hardware and computer instructions.

Various embodiments of the disclosure have been described above. The foregoing descriptions are exemplary, not exhaustive, and not limited by the disclosed embodiments. Numerous modifications and variations will be apparent to those of ordinary skill in the art without departing from the scope and spirit of the described embodiments. The terminology used herein was chosen to best explain the principles of the embodiments, the practical application or technical improvement over the technology in the marketplace, or to enable others of ordinary skill in the art to understand the embodiments disclosed herein.

In view of this, the disclosure provides a method for multi-modal service-based cell handover and related devices, which allows terminals involved in a multi-modal service to synchronously hand over to the same cell, thereby realizing synchronous transmission of the multi-modal service in the communication system.

In a first aspect, embodiments of the disclosure provide a method for multi-modal service-based cell handover. The method includes: transmitting, by a first base station, a first message to a second base station, where the first message includes device identifier information of multiple terminals and service identifier information of a first multi-modal service, the multiple terminals are terminals in a source cell of the first base station that carry data of the first multi-modal service, and the first message is used for the first base station to request the second base station to perform handover preparation; receiving, by the first base station, a second message from the second base station, where the second message indicates that the second base station completes the handover preparation; and transmitting, by the first base station, a third message to the multiple terminals, where the third message indicates a target cell for handover.

In a possible embodiment, transmitting, by the first base station, the first message to the second base station includes: the first message includes at least one of: a terminal identifier set, a first service identifier, a first data flow identifier set, a first admission identifier, and a second admission identifier, the terminal identifier set indicates the multiple terminals, the first service identifier indicates the first multi-modal service, the first data flow identifier set indicates data flows of the first multi-modal service, the first admission identifier includes an entire admission identifier or a partial admission identifier, the entire admission identifier indicates that the second base station admits all of the data flows of the first multi-modal service, the partial admission identifier indicates that the second base station admits part of the data flows of the first multi-modal service, and the second admission identifier indicates whether any of the data flows should be admitted when the first multi-modal service is admitted, and transmitting, by the first base station, the first message to the second base station in a predefined manner, where the predefined manner includes HANDOVER REQUEST and HANDOVER REQUIRED.

In a possible embodiment, transmitting, by the first base station, the first message to the second base station includes: the first message includes at least one of: multiple terminal identifiers, multiple first service identifiers, multiple data flow identifiers, multiple first admission identifiers, and multiple second admission identifiers, each terminal identifier indicates a corresponding terminal, each data flow identifier indicates one data flow of the first multi-modal service transmitted by a corresponding terminal, each first admission identifier indicates that the second base station admits all of data flows of the first multi-modal service transmitted by a corresponding terminal or indicates that the second base station can only admit part of the data flows of the first multi-modal service transmitted by the corresponding terminal, and each second admission identifier indicates whether any of data flows should be admitted when the first multi-modal service is admitted, and transmitting, by the first base station, multiple first messages to the second base station of a second cell in a predefined manner, where each first message includes at least one of: one terminal identifier, one first service identifier, one data flow identifier, one first admission identifier, and one second admission identifier, and the predefined manner includes HANDOVER REQUEST and HANDOVER REQUIRED.

In a possible embodiment, transmitting, by the first base station, the third message to the multiple terminals includes: transmitting, by the first base station, a handover command to the multiple terminals, where the handover command indicates the multiple terminals to hand over to the target cell.

In a possible embodiment, transmitting, by the first base station, the third message to the multiple terminals includes: transmitting, by the first base station, a conditional handover command to the multiple terminals, where the conditional handover command includes handover conditions of candidate cells, and the target cell is any of the candidate cells.

In a possible embodiment, after transmitting, by the first base station, a conditional handover command to the multiple terminals, the method further includes: receiving, by the first base station, a fourth message from the second base station, where the fourth message includes a first service identifier, a target cell identifier, and a terminal access state identifier, and the terminal access state identifier includes a terminal identifier corresponding to a terminal that has not accessed the target cell in multiple terminal identifiers or a terminal identifier set and a terminal identifier corresponding to a terminal that has accessed the target cell in the multiple terminal identifiers or the terminal identifier set; and transmitting, by the first base station, a handover command to a terminal that is to access but has not accessed the target cell, where the handover command indicates the terminal to hand over to the target cell.

In a second aspect, embodiments of the disclosure provide a method for multi-modal service-based cell handover. The method includes: reporting, by a first terminal, a first measurement report to a first base station, where the first terminal is any of multiple terminals, and the multiple terminals are terminals in a source cell of the first base station that carry data of a first multi-modal service; receiving, by the first terminal, a third message from the first base station, where the third message indicates a target cell for handover; and accessing, by the first terminal, the target cell according to the third message.

In a possible embodiment, the third message includes a handover command, and receiving, by the first terminal, the third message from the first base station includes: initiating, by the first terminal, access to the target cell according to the handover command.

In a possible embodiment, the third message includes a conditional handover command, and receiving, by the first terminal, the third message from the first base station includes: initiating, by the first terminal, access to the target cell in response to a handover condition of the target cell contained in the conditional handover command being satisfied.

In a possible embodiment, after accessing, by the first terminal, the second cell, the method further includes: determining, by the first terminal, a terminal that is to access but has not accessed the target cell among the multiple terminals; and transmitting, by the first terminal, a fifth message to the terminal, where the fifth message includes a target cell identifier and indicates the terminal to access the target cell.

In a third aspect, embodiments of the disclosure provide a method for multi-modal service-based cell handover. The method includes: receiving, by a second base station, a first message from a first base station, where the first message includes device identifier information of multiple terminals and service identifier information of a first multi-modal service, the multiple terminals are terminals in a source cell of the first base station that carry data of the first multi-modal service; determining, by the second base station, a handover preparation state according to the first message, where the handover preparation state includes handover preparation completion; and transmitting, by the second base station, a second message to the first base station, where the second message indicates that the second base station completes handover preparation.

In a possible embodiment, the second message includes HANDOVER REQUEST ACKNOWLEDGE.

In a possible embodiment, the handover preparation state further includes handover preparation failure, and after determining, by the second base station, the handover preparation state according to the first message, the method further includes: transmitting, by the second base station, a sixth message to the first base station, where the sixth message includes HANDOVER PREPARATION FAILURE or ANDOVER REQUEST ACKNOWLEDGE and indicates that the first multi-modal service fails to be admitted.

In a possible embodiment, receiving, by the second base station, the first message from the first base station includes: receiving, by the second base station, one first message from the first base station, where the first message includes at least one of: a terminal identifier set, a first service identifier, a first data flow identifier set, a first admission identifier, and a second admission identifier, the terminal identifier set indicates the multiple terminals, the first service identifier indicates the first multi-modal service, the first data flow identifier set indicates data flows of the first multi-modal service, the first admission identifier includes an entire admission identifier or a partial admission identifier, the entire admission identifier indicates that the second base station admits all of the data flows of the first multi-modal service, the partial admission identifier indicates that the second base station admits part of the data flows of the first multi-modal service, and the second admission identifier indicates whether any of the data flows should be admitted when the first multi-modal service is admitted.

In a possible embodiment, receiving, by the second base station, the first message from the first base station includes: receiving, by the second base station, multiple first messages from the first base station, where each first message includes at least one of: one terminal identifier, one first service identifier, one data flow identifier, one first admission identifier, and one second admission identifier, each terminal identifier indicates a corresponding terminal, each data flow identifier indicates one data flow of a multi-modal service transmitted by a corresponding terminal, each first admission identifier indicates that the second base station admits all of data flows of the first multi-modal service transmitted by a corresponding terminal or indicates that the second base station can only admit part of the data flows of the first multi-modal service transmitted by the corresponding terminal, and each second admission identifier indicates whether any of data flows should be admitted when the first multi-modal service is admitted.

In a possible embodiment, determining, by the second base station, the handover preparation state according to the first message includes: determining, by the second base station, the handover preparation state according to at least one of: a terminal identifier set, a first service identifier, a first data flow identifier set, a first admission identifier, and a second admission identifier included in one first message; or determining, by the second base station, the handover preparation state according to at least one of: one terminal identifier, one first service identifier, one data flow identifier, one first admission identifier, and one second admission identifier included in each of multiple first messages.

In a fourth aspect, embodiments of the disclosure provide a device for multi-modal service-based cell handover. The device includes a first transmitting module, a first receiving module, and a second transmitting module. The first transmitting module is configured to transmit a first message to a second base station, where the first message includes device identifier information of multiple terminals and service identifier information of a first multi-modal service, and the multiple terminals are terminals in a source cell of the first base station that carry data of the first multi-modal service. The first receiving module is configured to receive a second message from the second base station, where the second message indicates that the second base station completes the handover preparation. The second transmitting module is configured to transmit a third message to the multiple terminals, where the third message indicates a target cell.

In a fifth aspect, embodiments of the disclosure provide a device for multi-modal service-based cell handover. The device includes a reporting module, a second receiving module, and a handover module. The reporting module is configured to report a first measurement report to a first base station, where the first terminal is any of multiple terminals, and the multiple terminals are terminals in a source cell of the first base station that carry data of a first multi-modal service. The second receiving module is configured to receive a third message from the first base station, where the third message indicates a target cell. The handover module is configured to access the target cell according to the third message.

In a sixth aspect, embodiments of the disclosure provide a device for multi-modal service-based cell handover. The device includes a third receiving module, a preparation module, and a third transmitting module. The third receiving module is configured to receive a first message from a first base station, where the first message includes device identifier information of multiple terminals and service identifier information of a first multi-modal service, the multiple terminals are terminals in a source cell of the first base station that carry data of the first multi-modal service. The preparation module is configured to determine a handover preparation state according to the first message, where the handover preparation state includes handover preparation completion. The third transmitting module is configured to transmit a second message to the first base station, where the second message indicates that the second base station completes handover preparation.

In a seventh aspect, embodiments of the disclosure provide a base station device. The base station device includes a memory and a processor. The memory stores computer programs executable on the processor. The computer programs are operable with the processor to perform steps of the method for cell handover described in any of the first aspect of embodiments of the disclosure.

In an eighth aspect, embodiments of the disclosure provide a terminal device. The terminal device includes a memory and a processor. The memory stores computer programs executable on the processor. The computer programs are operable with the processor to perform steps of the method for cell handover described in any of the second aspect of embodiments of the disclosure.

In a ninth aspect, the disclosure provides a base station device. The base station device includes a memory and a processor. The memory stores computer programs executable on the processor. The computer programs are operable with the processor to perform steps of the method for cell handover described in any of the third aspect of embodiments of the disclosure.

In a tenth aspect, embodiments of the disclosure provide a computer storage medium. The computer programs include program instructions which, when executed by a processor, cause the processor to perform the method described in any of the first aspect, the second aspect, and the third aspect of embodiments of the disclosure.

1. A method for multi-modal service-based cell handover, comprising:
transmitting, by a first base station, a first message to a second base station, wherein the first message comprises device identifier information of a plurality of terminals and service identifier information of a first multi-modal service, the plurality of terminals are terminals in a source cell of the first base station that carry data of the first multi-modal service, and the first message is used for the first base station to request the second base station to perform handover preparation;
receiving, by the first base station, a second message from the second base station, wherein the second message indicates that the second base station completes the handover preparation; and
transmitting, by the first base station, a third message to the plurality of terminals, wherein the third message indicates a target cell for handover.

2. The method of claim 1, wherein
the first message comprises at least one of: a terminal identifier set, a first service identifier, a first data flow identifier set, a first admission identifier, and a second admission identifier, the terminal identifier set indicates the plurality of terminals, the first service identifier indicates the first multi-modal service, the first data flow identifier set indicates data flows of the first multi-modal service, the first admission identifier comprises an entire admission identifier or a partial admission identifier, the entire admission identifier indicates that the second base station admits all of the data flows of the first multi-modal service, the partial admission identifier indicates that the second base station admits part of the data flows of the first multi-modal service, and the second admission identifier indicates whether any of the data flows should be admitted when the first multi-modal service is admitted, and
transmitting, by the first base station, the first message to the second base station comprises:
transmitting, by the first base station, the first message to the second base station in a predefined manner, wherein the predefined manner comprises HANDOVER REQUEST and HANDOVER REQUIRED.

3. The method of claim 1, wherein
the first message comprises at least one of: a plurality of terminal identifiers, a plurality of first service identifiers, a plurality of data flow identifiers, a plurality of first admission identifiers, and a plurality of second admission identifiers, each terminal identifier indicates a corresponding terminal, each data flow identifier indicates one data flow of the first multi-modal service transmitted by a corresponding terminal, each first admission identifier indicates that the second base station admits all of data flows of the first multi-modal service transmitted by a corresponding terminal or indicates that the second base station can only admit part of the data flows of the first multi-modal service transmitted by the corresponding terminal, and each second admission identifier indicates whether any of data flows should be admitted when the first multi-modal service is admitted, and
transmitting, by the first base station, the first message to the second base station comprises:
transmitting, by the first base station, a plurality of first messages to the second base station of a second cell in a predefined manner, wherein each first message comprises at least one of: one terminal identifier, one first service identifier, one data flow identifier, one first admission identifier, and one second admission identifier, and the predefined manner comprises HANDOVER REQUEST and HANDOVER REQUIRED.

4. The method of claim 1, wherein transmitting, by the first base station, the third message to the plurality of terminals comprises:
transmitting, by the first base station, a handover command to the plurality of terminals, wherein the handover command indicates the plurality of terminals to hand over to the target cell.

5. The method of claim 1, wherein transmitting, by the first base station, the third message to the plurality of terminals comprises:
transmitting, by the first base station, a conditional handover command to the plurality of terminals, wherein the conditional handover command comprises handover conditions of candidate cells, and the target cell is any of the candidate cells.

6. The method of claim 1, wherein after transmitting, by the first base station, a conditional handover command to the plurality of terminals, the method further comprises:
receiving, by the first base station, a fourth message from the second base station, wherein the fourth message comprises a first service identifier, a target cell identifier, and a terminal access state identifier, and the terminal access state identifier comprises a terminal identifier corresponding to a terminal that has not accessed the target cell in a plurality of terminal identifiers or a terminal identifier set and a terminal identifier corresponding to a terminal that has accessed the target cell in the plurality of terminal identifiers or the terminal identifier set; and
transmitting, by the first base station, a handover command to a terminal that is to access but has not accessed the target cell, wherein the handover command indicates the terminal to hand over to the target cell.

7. A method for multi-modal service-based cell handover, comprising:
reporting, by a first terminal, a first measurement report to a first base station, wherein the first terminal is any of a plurality of terminals, and the plurality of terminals are terminals in a source cell of the first base station that carry data of a first multi-modal service;
receiving, by the first terminal, a third message from the first base station, wherein the third message indicates a target cell for handover; and
accessing, by the first terminal, the target cell according to the third message.

8. The method of claim 7, wherein the third message comprises a handover command, and receiving, by the first terminal, the third message from the first base station comprises:
initiating, by the first terminal, access to the target cell according to the handover command.

9. The method of claim 7, wherein the third message comprises a conditional handover command, and receiving, by the first terminal, the third message from the first base station comprises:
initiating, by the first terminal, access to the target cell in response to a handover condition of the target cell contained in the conditional handover command being satisfied.

10. The method of claim 9, wherein after accessing, by the first terminal, the target cell, the method further comprises:
determining, by the first terminal, a terminal that is to access but has not accessed the target cell among the plurality of terminals; and
transmitting, by the first terminal, a fifth message to the terminal, wherein the fifth message comprises a target cell identifier and indicates the terminal to access the target cell.

11. A method for multi-modal service-based cell handover, comprising:
receiving, by a second base station, a first message from a first base station, wherein the first message comprises device identifier information of a plurality of terminals and service identifier information of a first multi-modal service, the plurality of terminals are terminals in a source cell of the first base station that carry data of the first multi-modal service;
determining, by the second base station, a handover preparation state according to the first message, wherein the handover preparation state comprises handover preparation completion; and
transmitting, by the second base station, a second message to the first base station, wherein the second message indicates that the second base station completes handover preparation.

12. The method of claim 11, wherein the second message comprises HANDOVER REQUEST ACKNOWLEDGE.

13. The method of claim 11, wherein the handover preparation state further comprises handover preparation failure, and after determining, by the second base station, the handover preparation state according to the first message, the method further comprises:
transmitting, by the second base station, a sixth message to the first base station, wherein the sixth message comprises HANDOVER PREPARATION FAILURE or ANDOVER REQUEST ACKNOWLEDGE and indicates that the first multi-modal service fails to be admitted.

14. The method of claim 11, wherein receiving, by the second base station, the first message from the first base station comprises:
receiving, by the second base station, one first message from the first base station, wherein the first message comprises at least one of: a terminal identifier set, a first service identifier, a first data flow identifier set, a first admission identifier, and a second admission identifier, the terminal identifier set indicates the plurality of terminals, the first service identifier indicates the first multi-modal service, the first data flow identifier set indicates data flows of the first multi-modal service, the first admission identifier comprises an entire admission identifier or a partial admission identifier, the entire admission identifier indicates that the second base station admits all of the data flows of the first multi-modal service, the partial admission identifier indicates that the second base station admits part of the data flows of the first multi-modal service, and the second admission identifier indicates whether any of the data flows should be admitted when the first multi-modal service is admitted.

15. The method of claim 11, wherein receiving, by the second base station, the first message from the first base station comprises:
receiving, by the second base station, a plurality of first messages from the first base station, wherein each first message comprises at least one of: one terminal identifier, one first service identifier, one data flow identifier, one first admission identifier, and one second admission identifier, each terminal identifier indicates a corresponding terminal, each data flow identifier indicates one data flow of a multi-modal service transmitted by a corresponding terminal, each first admission identifier indicates that the second base station admits all of data flows of the first multi-modal service transmitted by a corresponding terminal or indicates that the second base station can only admit part of the data flows of the first multi-modal service transmitted by the corresponding terminal, and each second admission identifier indicates whether any of data flows should be admitted when the first multi-modal service is admitted.

16. The method of claim 11, wherein determining, by the second base station, the handover preparation state according to the first message comprises:
determining, by the second base station, the handover preparation state according to at least one of: a terminal identifier set, a first service identifier, a first data flow identifier set, a first admission identifier, and a second admission identifier comprised in one first message; or
determining, by the second base station, the handover preparation state according to at least one of: one terminal identifier, one first service identifier, one data flow identifier, one first admission identifier, and one second admission identifier comprised in each of a plurality of first messages.

17-19. (canceled)

20. A base station device comprising:
a transceiver;
a memory configured to store computer programs; and
a processor configured to invoke and execute the computer programs stored in the memory to cause the transceiver to perform the method of claim 1.

21. A terminal device comprising:
a transceiver;
a memory configured to store computer programs; and
a processor configured to invoke and execute the computer programs stored in the memory to perform the method of claim 7.

22. A base station device comprising:
a transceiver;
a memory configured to store computer programs; and
a processor configured to invoke and execute the computer programs stored in the memory to perform the method of claim 11.

23. (canceled)

24. The base station device of claim 20, wherein
the first message comprises at least one of: a terminal identifier set, a first service identifier, a first data flow identifier set, a first admission identifier, and a second admission identifier, the terminal identifier set indicates the plurality of terminals, the first service identifier indicates the first multi-modal service, the first data flow identifier set indicates data flows of the first multi-modal service, the first admission identifier comprises an entire admission identifier or a partial admission identifier, the entire admission identifier indicates that the second base station admits all of the data flows of the first multi-modal service, the partial admission identifier indicates that the second base station admits part of the data flows of the first multi-modal service, and the second admission identifier indicates whether any of the data flows should be admitted when the first multi-modal service is admitted, and
the processor is configured to cause the transceiver to:
transmit the first message to the second base station in a predefined manner, wherein the predefined manner comprises HANDOVER REQUEST and HANDOVER REQUIRED.
